(19) United States
(12) Patent Application Publication
(10) Pub. No.: US 2014/0178013 A1
(43) Pub. Date: Jun. 26, 2014

(54) FLUTES FOR FERRULE TO FIBER BONDING

(71) Applicant: CommScope, Inc. of North Carolina, Hickory, NC (US)

(72) Inventor: Jeffrey D. Nielson, Longmont, CO (US)

(73) Assignee: CommScope, Inc. of North Carolina, Hickory, NC (US)

(21) Appl. No.: 14/140,137

(22) Filed: Dec. 24, 2013

Related U.S. Application Data
(60) Provisional application No. 61/745,829, filed on Dec. 26, 2012.

(51) Int. Cl. G02B 6/38; G02B 6/02

(52) U.S. Cl. CPC G02B 6/3838; G02B 6/02; G02B 6/3839
USPC 385/83; 385/123

(57) ABSTRACT

An optical connector includes a ferrule having first and second ends. At least one substantially circular channel extends between the first and second ends. The at least one channel has an inner diameter. A substantially circular optical fiber, having an outer diameter, resides within the channel. At least one groove is formed into the inner diameter of the channel, and/or at least one notch is formed into the outer diameter of the optical fiber. Epoxy resides within the at least one groove and/or at least one notch to attach the optical fiber within the channel.

### BACKGROUND OF THE INVENTION

1. Field of the Invention

The present invention relates to optical fiber connecting hardware. More particularly, the present invention relates to a ferrule and/or optical fiber optimized for epoxy usage when terminating an optical fiber within a ferrule.

2. Description of the Related Art

It is known in the background art, that a fiber optic cable may be cut and terminated at a connector, jumper or attenuator, or other such structure. A typical termination includes a ferrule having a central bore passing through a center thereof. A length of optical fiber is exposed at the end of the cut fiber optic cable. The optical fiber is passed through the central bore in the ferrule and cut flush with the end of the ferrule. An epoxy secures the optical fiber within the central bore, and the cut end of the optical fiber is polished, along with the end of the ferrule, to finish the termination.

U.S. Pat. No. 6,074,100, which is herein incorporated by reference, shows a ferrule and typical termination method using a ferrule.

FIGS. 12-16 illustrate the terminus of U.S. Pat. No. 6,074,100. In FIG. 12, the fiber optic cable 208 is stripped to remove and expose several sheaths of cable material. The stripped end of the fiber optic cable 208 includes a central optical fiber 212, a silicon buffer 214 disposed about the optical fiber 212, an inner jacket 216 enveloping the silicon buffer 214, a strengthening member 218 comprising a braided or woven fiber, e.g., a polyamide fiber such as Kevlar®, wrapped about the inner jacket 216, and an outer jacket 220 enveloping the strengthening member 218. Although U.S. Pat. No. 6,074,100 shows a silicon buffer 214, other types of polymer buffers are known, such as polyetherimide and acrylate.

In FIG. 13, the stripped end of the fiber optic cable 208 is prepared for bonding to a ferrule assembly 222. The ferrule assembly 222 includes a rigid ferrule 224 and an aft body or sleeve 226 circumscribing and bonded to an end portion of the rigid ferrule 224. More specifically, the rigid ferrule 224 defines an external face surface 228, a central bore 230 and an internal end 232, and the aft body 226 comprises a cylindrical inner bore 234 and a tapered end 236 defining a cylindrical outer surface 238. The rigid ferrule 224 is fabricated from a ceramic, such as zirconia, and the aft body 226 is fabricated from stainless steel.

In preparation for bonding, a bead or ring of bonding adhesive 240 is applied to the outer surface 238 of the aft body 226, corresponding to region A, and a layer of bonding adhesive 242, corresponding to region B, is applied to the optical fiber 212 and inner jacket 216. The bonding adhesives 240, 242 in regions A and B are the same and, furthermore, are selected such that the Glass Transition Temperature (TG) is greater than the maximum temperature anticipated in the operating environment of the terminus. Prior to bonding, the strengthening members 218 are folded rearwardly over the outer jacket 220. A shrink tubing 244, which will subsequently overlay the strengthening member 218, is used to temporarily preposition the strengthening member 218 over the outer jacket 220.

In FIG. 14, the stripped end of the fiber optic cable 208 is inserted within the ferrule assembly 222 such that the optical fiber 212 passes through the ferrule bore 230 and the inner jacket 216 abuts the internal end 232 of the rigid ferrule 224. Next, the shrink tubing 244 is slid rearwardly (shown in phantom) to release the strengthening member 218 which is then folded over the cylindrical outer surface 238 of the aft body 226. As such, the ring of bonding adhesive 240 in region A contacts and impregnates the strengthening member 218. The shrink tubing 244 is then moved forwardly such that it overlays the strengthening member 218 and the outer jacket 220. During a curing process, the adhesive 240 is solidified and the shrink tube 244 contracts. After the curing process, the end of the optical fiber 212 is cleaved in close proximity to the external face surface 228 of the rigid ferrule 224, as illustrated in FIG. 14.

Then, various sanding or polishing operations are preformed in order to recess the cut end of the optical fiber 212 below the external face surface 228 of the rigid ferrule 224, as illustrated in FIGS. 15 and 16. Specifically, the end profile 250 is characterized by the optical fiber 212 defining an end surface 252 which is recessed or undercut relative to the face surface 228 of the rigid ferrule 224 (as best shown in FIG. 15). The end surface of the optical fiber 212 is at least the combination of the light-carrying core 212_{CO} and its surrounding cladding 212_{CL}. Although U.S. Pat. No. 6,074,100 shows the end surface 252 being recessed or undercut relative to the face surface 228, it is common in the existing art for the end surface 252 to protrude from the face surface 228, so the fiber end is compressed when connectors are mated in an adapter.

### SUMMARY OF THE INVENTION

The present invention includes an improved system for dealing with the epoxy 242 in section B of FIG. 13. In the prior art, the central bore or channel 230 in the rigid ferrule 224 has a greater inner diameter (ID) than the outer diameter (OD) of the optical fiber 212. The greater ID allows the epoxy 242 to be accommodated. If the ID of the channel 230 were exactly the same as the OD of the optical fiber 212, the epoxy 242 would be pushed off of the optical fiber 212, as the optical fiber 212 is inserted into the channel 230.

The Applicants have appreciated drawbacks in the connector designs in the prior art due to the dimensional relationship between the ID of the rigid ferrule 224 and the OD of the optical fiber 212. For example, play exists between the ID of the rigid ferrule 224 and the OD of the optical fiber 212. The play is provided to accommodate the existence of the epoxy 242 between the ID of the channel 230 and the OD of the optical fiber 212. However, the play can sometimes allow the optical fiber 212 to abut against one side of the ID of the channel 230 and create a maximum gap between the ID of the channel 230 and the OD of the optical fiber 212 on the opposite side of the optical fiber 212. Hence, the center axis of the optical fiber 212 is not concentric with the center axis of the channel 230, and/or is not controlled to remain concentric along the length of the fiber optic cable 208.

When the center axis of the optical fiber 212 is not concentric with the center axis of the channel 230, there can be signal loss, e.g., attenuation, at the connector's interface, e.g., polished end profile 250, as it communicates the optical fiber's signal to another optical fiber end profile 250 or to a device. In other words, the two abutting fiber end profiles 250 at a connection will not be properly aligned and light will not completely pass between the two misaligned fiber end profiles 250.

It is an objective of the present invention to address the above described drawbacks and other perceived drawbacks in the optical fiber terminations of the background art.

These and other objectives are accomplished by a device comprising a ferrule having a first end and a second end; a substantially circular channel extending from said first end of said ferrule to said second end of said ferrule, said channel having an inner diameter; and at least one groove formed into said inner diameter of said channel and extending from said first end of said ferrule to said second end of said ferrule.

These and other objectives are further accomplished by a device comprising a substantially circular optical fiber, said optical fiber having an outer diameter; and at least one notch formed into said outer diameter of said optical fiber, wherein said notch extends in a longitudinal direction of said optical fiber.

These and other objectives are yet further accomplished by a device comprising a ferrule having a first end and a second end; a substantially circular channel extending from said first end of said ferrule to said second end of said ferrule, said channel having an inner diameter; a substantially circular optical fiber, said optical fiber having an outer diameter and residing within said channel; at least one groove or notch formed into said inner diameter of said channel or said outer diameter of said optical fiber; and epoxy within said at least one groove or notch attaching said optical fiber within said channel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a ferrule, in accordance with the present invention;

FIG. 2 is a side view of the ferrule of FIG. 1, illustrating in dashed lines a channel within the ferrule;

FIG. 3 is a close up perspective view of a first end of the ferrule of FIG. 1;

FIG. 4 is a view directly facing the first end of the ferrule of FIG. 1;

FIG. 5 is a perspective view of the ferrule, in accordance with FIGS. 1-4, combined with a retaining sleeve;

FIG. 6 is a is a perspective view of a cap sleeve slid over an end of the ferrule of FIG. 5 to form an expanded beam terminus;

FIG. 7 is a view directly facing a termination end of a multi-channel ferrule, in accordance with the present invention;

FIG. 8 is a perspective view of an optical fiber, in accordance with the present invention;

FIG. 9 is a side view of the optical fiber of FIG. 8;

FIG. 10 is a close up perspective view of a termination end of the optical fiber of FIG. 8;

FIG. 11 is a view directly facing the termination end of the optical fiber of FIG. 8;

FIG. 12 is a side view, partially in cross section, illustrating an end of a fiber optic cable which has been stripped to reveal an optical fiber, in accordance with the prior art;

FIG. 13 is a side view, partially in cross section, illustrating the stripped end of FIG. 12 prepared for bonding to a ferrule assembly, in accordance with the prior art;

FIG. 14 illustrates the bonding of the stripped end to the ferrule assembly to form a terminus, in accordance with the prior art;

FIG. 15 is a cross sectional side view of the end of the terminus of FIG. 14 subsequent to a polishing operation; and

FIG. 16 is a cross sectional close-up view of the optical fiber at the end of the terminus of FIG. 15.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

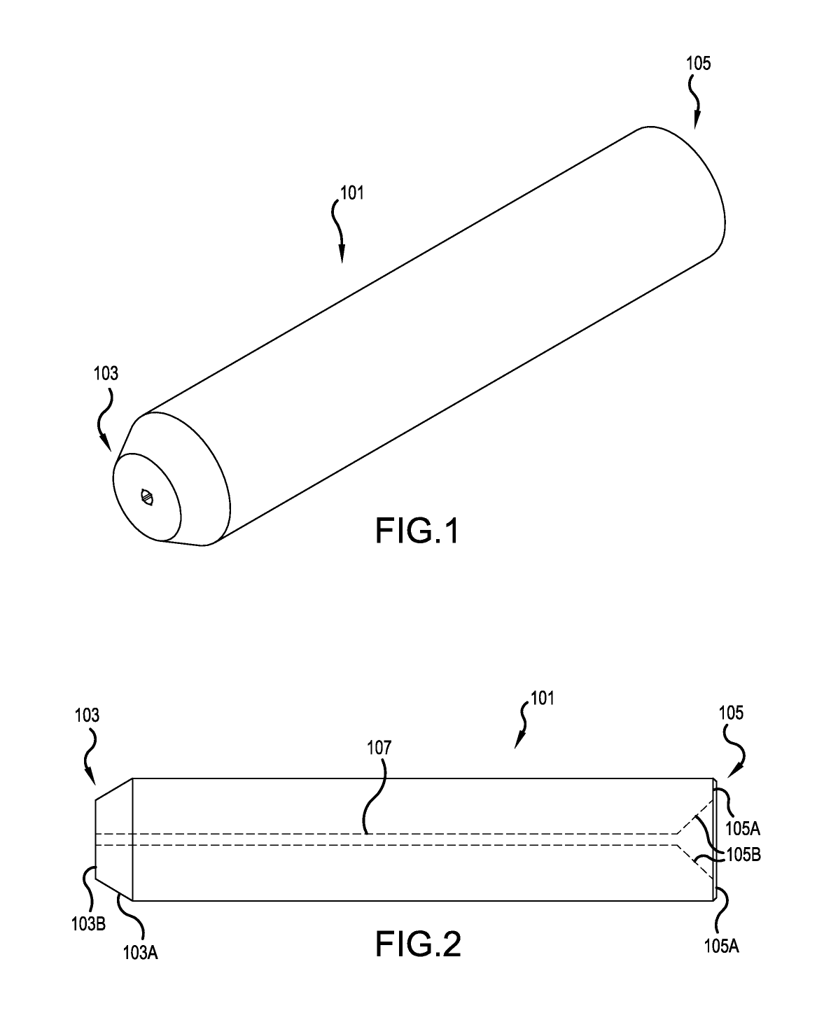

FIG. 1 is a perspective view of a ferrule 101, in accordance with the present invention. The ferrule 101 includes a first end 103 (e.g., the left side in FIG. 1) and a second end 105 (e.g., the right side in FIG. 1). The first end 103 may include a chamfered section 103A formed around a substantially flat front face 103B. The second end 105 may include a substantially flat ring 105A formed round a conical recess 105B.

FIG. 2 is a side view of the ferrule 101 of FIG. 1, illustrating, in dashed lines, a channel 107 within the ferrule 101. The channel 107 extends from a center of the substantially flat front face 103B of the first end 103 of the ferrule 101 to the center of the conical recess 105B of the second end 105 of the ferrule 101.

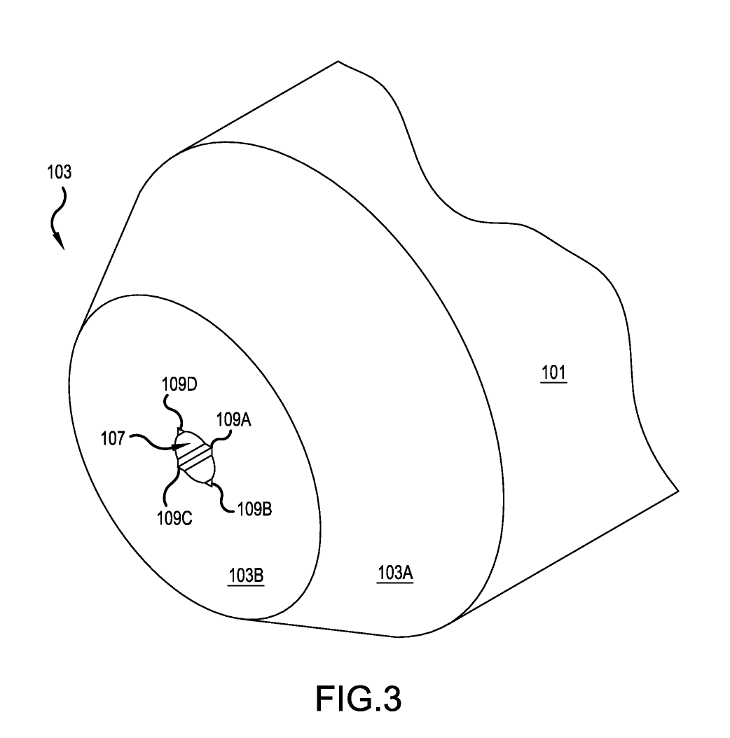

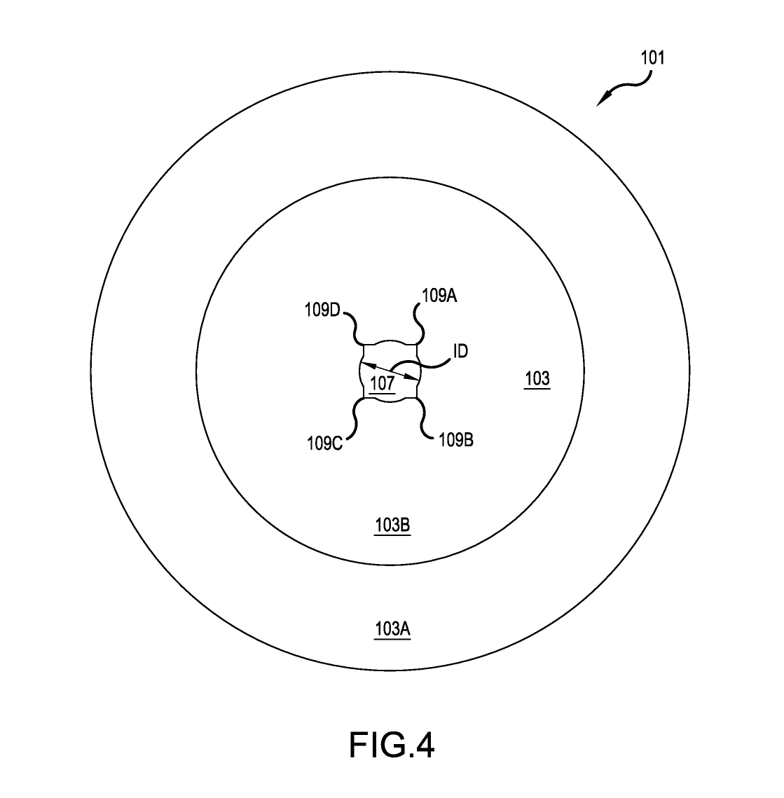

FIG. 3 is a close up perspective view of the first end 103 of the ferrule 101, and FIG. 4 is a view directly facing the first end 103 of the ferrule 101. As best seen in FIGS. 3-4, the channel 107 is substantially circular in cross section and has an inner diameter (ID), and is concentric with a center axis of the ferrule 101.

At least one groove 109 is formed into the inner diameter of the channel 107 and extends from the first end 103 of the ferrule 101 to the second end 105 of the ferrule 101. In a preferred embodiment, the at least one groove 109 includes a plurality of grooves, such as four grooves 109A, 109B, 109C and 109D, which are approximately equally spaced from each other around the inner circumference of the channel 107 and extending into a material forming the ferrule 101, e.g., a ceramic material. In FIGS. 3 and 4, there are four grooves 109A, 109B, 109C and 109D, however, more or fewer grooves 109 may be employed, such as three, five or six grooves 109. Also in the preferred embodiment, the grooves 109 are substantially v-shaped or u-shaped, however other shapes may be used if desired.

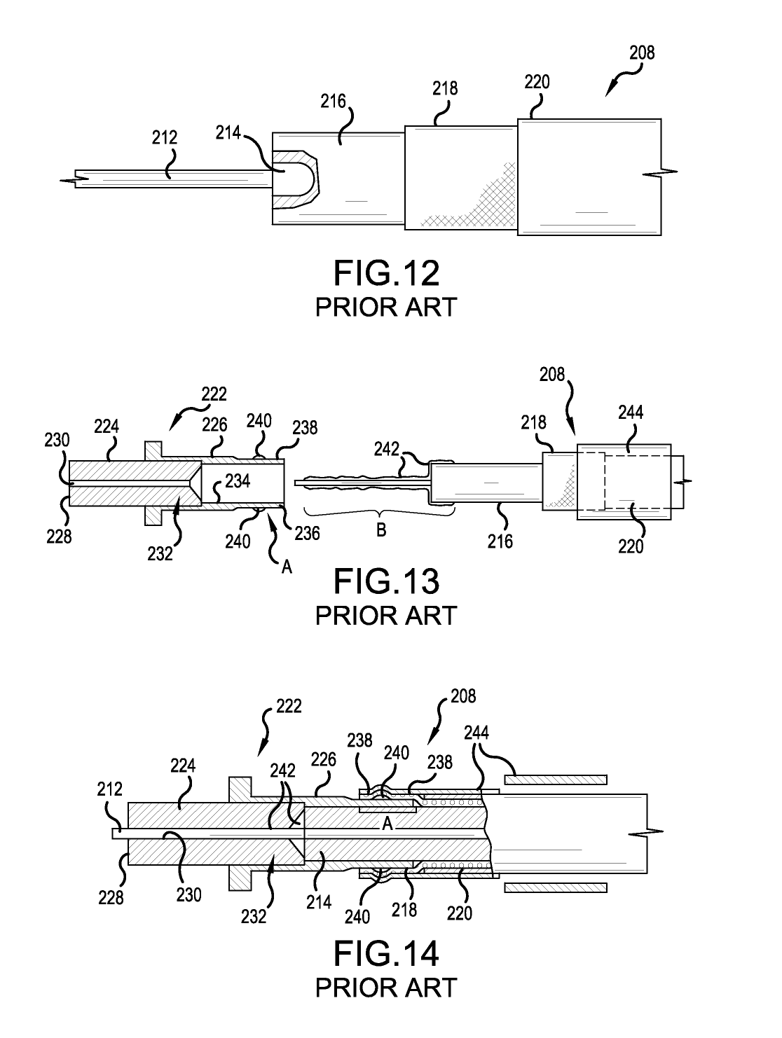

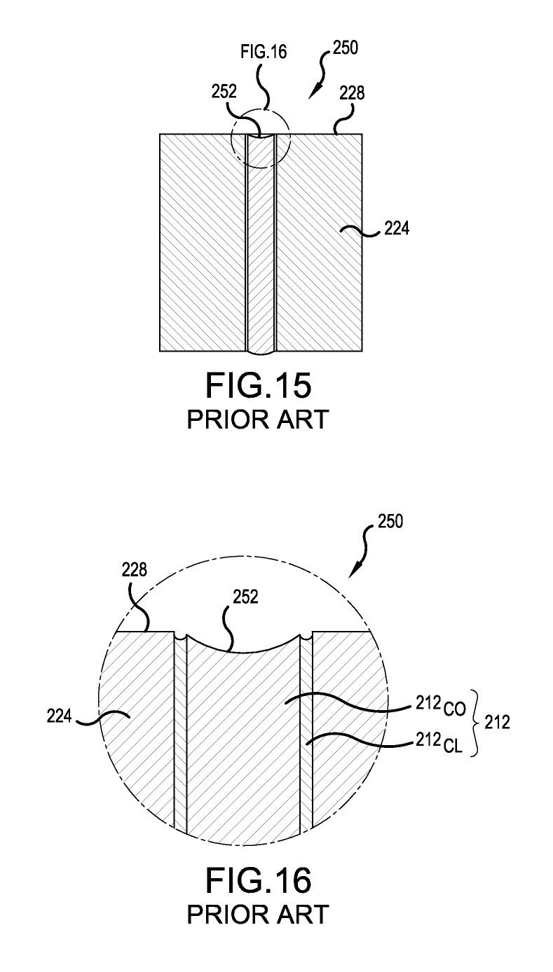

In use, a substantially circular optical fiber is inserted into the central channel 107 of the ferrule 101, such as the optical fiber 212 of the fiber optic cable 208, as shown in FIGS. 12-16. If the optical fiber 212 is first coated with an epoxy 242, like in section B of FIG. 13, prior to insertion into the channel 107, the epoxy 242 will be substantially pushed off of the optical fiber 212 in all areas except where the grooves 109 exist in the inner circumference of the channel 107, as the optical fiber 212 is pushed into the channel 107. The epoxy 242 will fill the grooves 109 of the channel 107 and attach the optical fiber 212 within the channel 107. Because the outer diameter OD of the optical fiber 212 is very close in dimension to, e.g., approximately equal to, the inner diameter ID of the channel 107, the center axis of the optical fiber 212 will be concentric with the center axis of the channel 107.

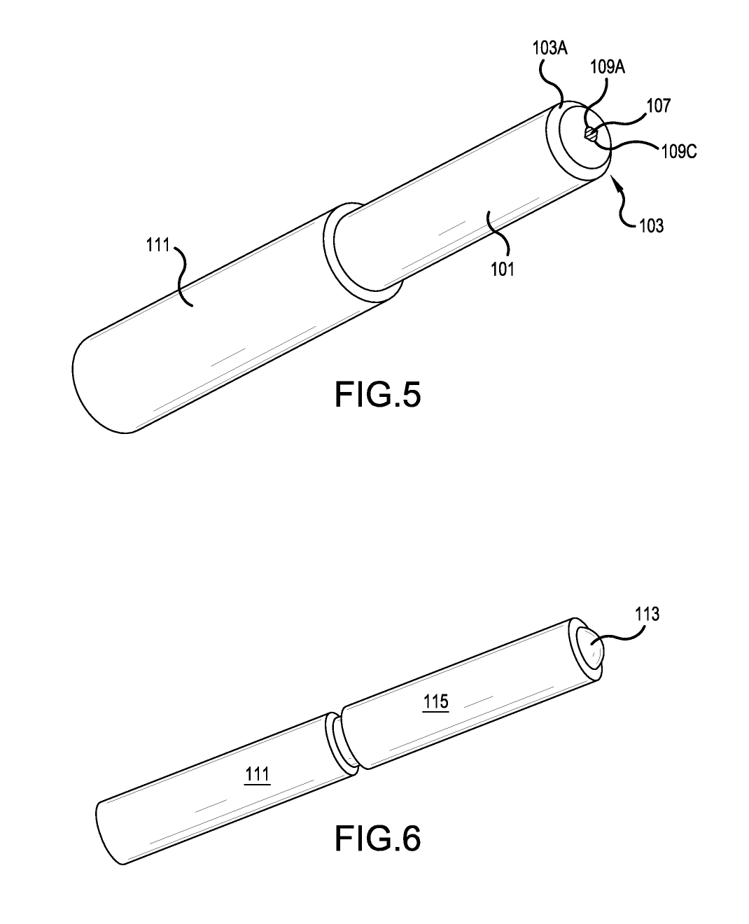

The fluted ferrule structures illustrated in FIGS. 1-4 also apply to expanded beam connectors and lens cap connectors, such as those described in the Assignee's prior U.S. Pat. Nos. 7,604,417; 7,625,129 and 8,393,804, which are all three herein incorporated by reference. For example, FIG. 5 shows the ferrule 101 captured within a sleeve 111. The central channel 107 includes the grooves 109, as detailed above.

As shown in FIG. 6, a ball lens 113 is captured within a cap 115. The cap 115 may be slid over the ferrule 101 and secured thereto, e.g., by epoxy. Because the optical fiber is accurately positioned within the center channel 107 of the ferrule 101, the end of the optical fiber 212, which is cleaved and polished at the first end 103 of the ferrule 101 will be nearly, exactly concentric with the center channel 107 and the overall ferrule 101, and hence will properly interface with the “center” of the backside of the ball lens 113 to deliver a maximum light signal into the center of the ball lens 113. More details about the expanded beam connector can be found in the above patents by the Assignee, previously incorporated by reference.

Some ferrules are designed to hold more than one optical fiber in an ordered array. Ferrules having multiple channels could also benefit by having the optical fibers held within the ferrule in such a way that the center axis of each optical fiber is located more precisely along the center axis of its respective channel.

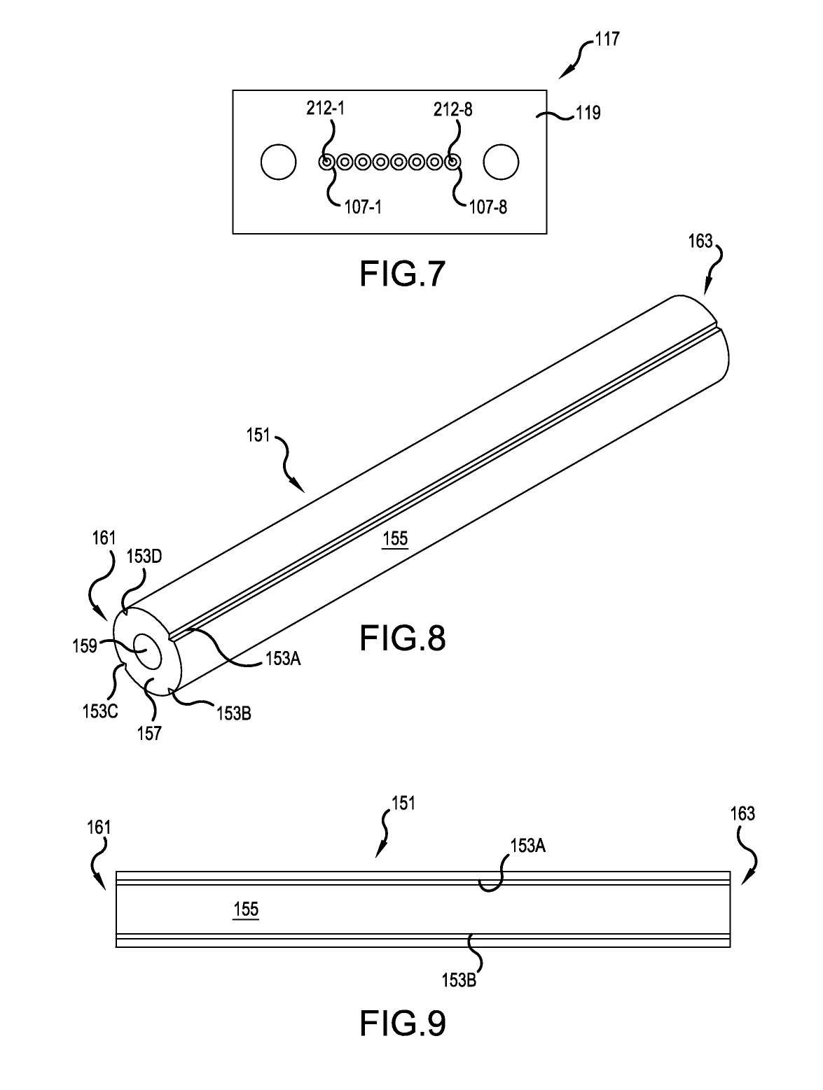

For example, FIG. 7 shows the termination face of an MPO or MTP connector 117, having an MT type ferrule 119. The MT type ferrule 119 includes several channels 107, such as eight channels 107-1 through 107-8 to hold eight optical fibers 212-1 through 212-8. Although the MT type ferrule 119 in FIG. 7 illustrates a single row of eight channels 107-1 through 107-8, more or fewer channels and/or rows of channels may be included in the MT type ferrule 119, such as two rows of eight channels 107 for sixteen total channels 107, or two rows of twelve channels or three rows of eight channels 107 for twenty four total channels 107.

Each channel 107-X of the MT type ferrule 119 can be sized to closely match the outer diameter OD of the optical fiber 212-X (e.g., exceeding the outer diameter OD of the optical fiber 212 by less than 4%, more preferably by less than 2%, and most preferably by less than 1%). Each channel 107-X of the MT type ferrule 119 may incorporate grooves 109 to hold epoxy, such that the optical fiber 212-X for that channel 107-X can be secured therein, even while the inner diameter of the channel 107-X is approximately equal to the outer diameter of the optical fiber 212-X.

FIG. 7 shows the MT type ferrule 119 holding eight optical fibers 212-1 through 212-8. Each channel 107-1 through 107-8 within the MT type ferrule 119 could include plural grooves 109, such as the four grooves 109A, 109B, 109C and 109D, as illustrated in FIG. 4, to hold epoxy for attaching the optical fiber 212-X within the channel 107-X.

To sum up the first embodiment, many optical fibers are connected using mechanical physical contact connectors. The fiber is typically bonded into a ceramic ferrule, cleaved and polished. The ferrule assembly is mated to a second ferrule assembly using a solid or split sleeve. The ferrule assemblies and sleeve are commonly surrounded by connector and adapter housings. A gap exists between the outer diameter of the fiber and the inner diameter of the channel within the ferrule. Epoxy is commonly located in the fiber-to-ferrule gap. The gap allows the fiber to move off center in the channel of the ferrule. Off center fibers align poorly, creating signal loss. The proposed fluted ferrule has longitudinal grooves along the ferrule's inner circumference to hold epoxy and form the fiber-to-ferrule bond. The ferrule channel's inner diameter ID can be reduced to provide better fiber alignment to the center of the channel, and lower signal loss across mated/facing fiber ends. Also, epoxy can be added after the fiber is inserted into the channel, hence reducing fiber breaks and scrap. One or more flutes (grooves) can be added to each ferrule, and the concept can be extended to multi-fiber ferrules and expanded beam terminations.

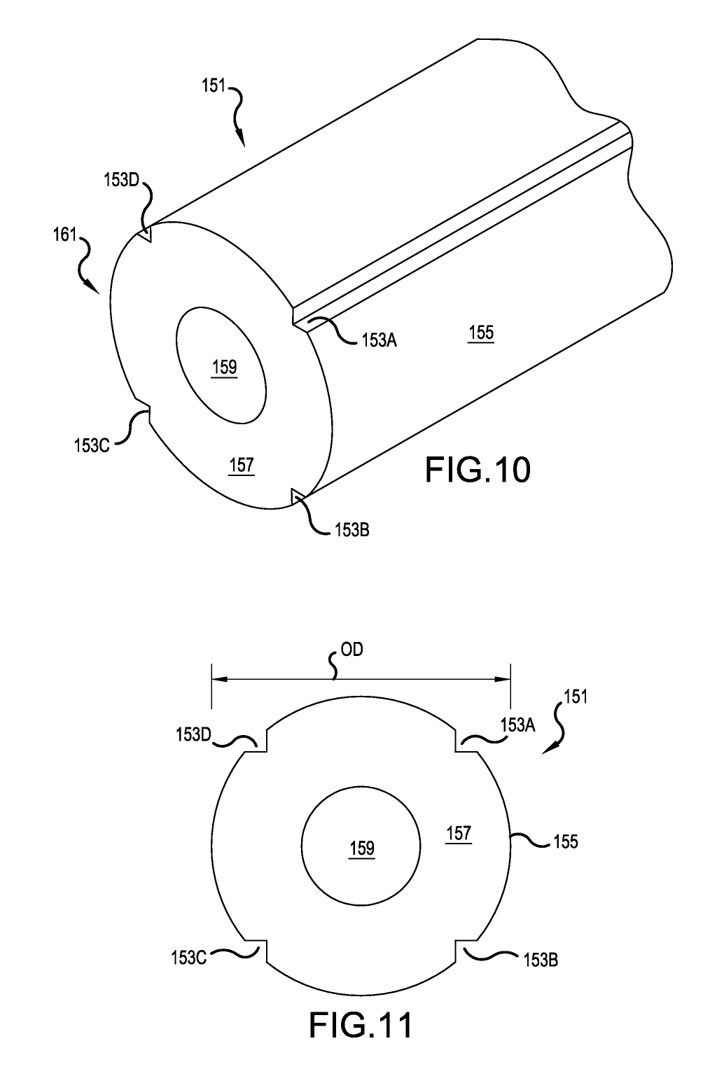

A second embodiment of the present invention is illustrated in FIGS. 8-11. A substantially circular optical fiber 151 has an outer diameter (OD) defined at a cylindrical outer surface 155 of its cladding layer 157, as shown in FIG. 11. The cladding layer 157 surrounds the light carrying medium 159, e.g., formed of glass or plastic. At least one notch 153 is formed into the cylindrical outer surface 155 of the optical fiber 151, penetrating into the cladding layer 157. The least one notch 153 extends in a longitudinal direction of the optical fiber 151 from a first end 161 of the optical fiber 151 to a second end 163 of the optical fiber 151.

In a preferred embodiment, the at least one notch 153 includes a plurality of notches, such as four notches 153A, 153B, 153C and 153D, approximately equally spaced from each other around the cylindrical outer surface 155 of the optical fiber 151 and extending into a material forming the cladding layer 157 of the optical fiber 151. In FIGS. 8-11, there are four notches 153A, 153B, 153C and 153D, however, more or fewer notches 153 may be employed, such as three, five or six notches 153. Also in the preferred embodiment, the notches 153 are substantially v-shaped or u-shaped, however other shapes may be used if desired.

Each notch 153 may extend into the cladding layer 157 of the optical fiber 151 to a depth of at least one percent of a total diameter of the optical fiber 151. The notches 153 do not extend into the central, optical signal carrying medium 159, e.g., glass or optical plastic. For example, the notches 153 might extend into the cladding layer 157 of the optical fiber 151 by at least 2%, or more preferably by at least 4%, of the overall diameter OD of the optical fiber 151.

In use, the optical fiber 151 having the notches 153 in its cylindrical outer surface 155 is inserted into the central bore 230 of a rigid ferrule 224, such as the rigid ferrule 224 depicted in FIGS. 12-16. The optical fiber 151 may extend from a fiber optic cable 208, as shown on the right side of prior art FIGS. 12-14. If the optical fiber 151 is first coated with an epoxy 242, like in section B of FIG. 13, prior to insertion into the central bore 230, the epoxy 242 will be substantially pushed off of the optical fiber 151 in all areas except where the notches 153 exist in the cylindrical outer surface 155 of the optical fiber 151, as the optical fiber 151 is pushed into the central bore 230. The epoxy 242 will fill the notches 153 of the optical fiber 151 and attach the optical fiber 151 within the central bore 224. Because the cylindrical outer surface 155 of the optical fiber 151 is very close in dimension to, e.g., approximately equal to, the inner diameter ID of the central bore 230, the center axis of the optical fiber 151 will be concentric with the center axis of the central bore 230.

The first and second embodiments of the invention may be combined whereby both the inner diameter ID of the channel 107 includes grooves 109 and the cylindrical outer surface 155 of the optical fiber 151 includes notches 153.

In the background art, optical fibers are commonly terminated with a single fiber, physical contact connector. The fiber is bonded into a cylindrical ferrule, cleaved and polished to form a first ferrule assembly. The first ferrule assembly is mated to a second ferrule assembly using a circular solid or split sleeve that surrounds the outside surfaces of the cylindrical ferrules and brings the ferrule ends into proper end-to-end alignment. The ferrule assemblies are commonly surrounded by connector housings. The split or solid sleeve is commonly surrounded by an adapter housing.

The quality of the connection depends largely on how accurately the first fiber end is aligned to the second fiber end within the connector. In the prior art, a gap exists between the outside surface of the fiber and the inside surface of the ferrule through hole. The gap exists to provide space for epoxy that bonds the fiber into the ferrule through hole. The gap allows the center axis of the fiber to move away from the center axis of the ferrule in random directions. It is likely that fibers in two mated connectors (whether mated single channel connectors or mated multichannel connectors) are not perfectly aligned resulting in increased connection loss, e.g., signal attenuation across the connector.

In accordance with the first embodiment of the present invention, longitudinal grooves are added to the inside of the ferrule through hole or channel, and the diameter of the through channel (as measured between sections of the through channel not possessing the longitudinal grooves) is reduced, so that the diameter of the ferrule through channel within the ferrule more closely matches the outer diameter of the optical fiber to be held within the fiber through channel. The longitudinal grooves provide space for accommodating epoxy to bond the fiber to the ferrule. The smaller through hole diameter improves the fiber-to-channel concentricity, connector performance and reduces scrap, e.g., discarded or recycled connectors due to off-center optical fibers causing attenuation levels exceeding an acceptable threshold.

The longitudinal groove or grooves also allow epoxy to be applied after the fiber is inserted, e.g., by a syringe. Inserting the epoxy after the optical fiber is inserted into the ferrule through channel reduces the initial force needed to insert the optical fiber into the ferrule through channel, hence reducing fiber breaks and reducing scrap, e.g., discarded or recycled connectors due to defective connector performance resulting from fiber breakage within the connector.

In accordance with the second embodiment of the present invention, longitudinal notches are provided in the outer cylindrical surface of the optical fiber. The notches received the epoxy and allow the tolerance between the ferrule channel and the optical fiber to be much more closely matched. Hence, the same advantages, as outlined in connection with the grooves may be equally accomplished. It is also possible to include one or more grooves in the ferrule channel in combination with one or more notches in the outer cylindrical surface of the optical fiber. Again, the same advantages, as outlined in connection with the grooves may be equally accomplished.

Although the drawings have illustrated a single core optical fiber, the optical fiber may include multiple cores. Multi-core optical fiber also needs to be precisely concentrically located within its ferrule channel. With the smaller sizes of the satellite cores associated with multi-core optical fibers, the centering within the ferrule channel becomes even more important. Also, the ability to load a multi-core optical fiber into an empty channel, and then rotate the multi-core fiber to clock the satellite cores to a proper position prior to inserting epoxy into the grooves or notches, e.g., by a syringe, is particularly advantageous.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A device comprising:
a ferrule having a first end and a second end;
a substantially circular channel extending from said first end of said ferrule to said second end of said ferrule, said channel having an inner diameter; and
at least one groove formed into said inner diameter of said channel and extending from said first end of said ferrule to said second end of said ferrule.

2. The device according to claim 1, wherein said at least one groove includes a plurality of grooves approximately equally spaced from each other around said inner diameter of said channel and extending into said ferrule.

3. The device according to claim 1, wherein said channel is a first channel and said at least one groove is at least one first groove, and further comprising:
a second, substantially circular channel extending from said first end of said ferrule to said second end of said ferrule, said second channel having an inner diameter; and
at least one second groove formed into said inner diameter of said second channel and extending from said first end of said ferrule to said second end of said ferrule.

4. The device according to claim 3, further comprising:
a substantially circular first optical fiber, said first optical fiber residing within said first channel;
a substantially circular second optical fiber, said second optical fiber residing within said second channel;
first epoxy within said at least one first groove attaching said first optical fiber within said first channel; and
second epoxy within said at least one second groove attaching said second optical fiber within said second channel.

5. The device according to claim 1, further comprising:
a substantially circular optical fiber, said optical fiber having an outer diameter and residing within said channel; and
epoxy within said at least one groove attaching said optical fiber within said channel.

6. The device according to claim 5, wherein a dimension of said outer diameter of said optical fiber is approximately equal to a dimension of said inner diameter of said channel.

7. The device according to claim 5, wherein said optical fiber comprises:
at least one notch formed into said outer diameter of said optical fiber, wherein said notch extends into said optical fiber and extends in a longitudinal direction of said optical fiber, and wherein said epoxy fills said at least one notch further attaching said optical fiber within said channel.

8. The device according to claim 7, wherein said at least one notch includes a plurality of notches approximately equally spaced from each other around said outer diameter of said optical fiber, and wherein said epoxy fills said plurality of notches of said optical fiber attaching said optical fiber within said channel.

9. A device comprising:
a substantially circular optical fiber, said optical fiber having an outer diameter; and
at least one notch formed into said outer diameter of said optical fiber, wherein said notch extends in a longitudinal direction of said optical fiber.

10. The device according to claim 9, wherein said at least one notch includes a plurality of notches approximately equally spaced from each other around said outer diameter of said optical fiber.

11. The device according to claim 9, wherein said at least one notch extends into a cladding layer of said optical fiber to a depth of at least one percent of a diameter of said optical fiber.

12. The device according to claim 9, wherein said at least one notch is substantially v-shaped or u-shaped.

13. A device comprising:
a ferrule having a first end and a second end;
a substantially circular channel extending from said first end of said ferrule to said second end of said ferrule, said channel having an inner diameter;
a substantially circular optical fiber, said optical fiber having an outer diameter and residing within said channel;
at least one groove or notch formed into said inner diameter of said channel or said outer diameter of said optical fiber; and
epoxy within said at least one groove or notch attaching said optical fiber within said channel.

14. The device according to claim 13, wherein said at least one groove or notch includes a plurality of grooves approximately equally spaced from each other around said inner diameter of said channel and extending into said ferrule.

15. The device according to claim 13, wherein said at least one groove or notch includes a plurality of notches approximately equally spaced from each other around said outer diameter of said optical fiber and extending into said optical fiber.

16. The device according to claim 1, wherein said at least one groove is substantially v-shaped or u-shaped.

17. The device according to claim 1, wherein said at least one groove extends into said ferrule by an amount exceeding at least 1% of the inner diameter of said channel.

18. The device according to claim 1, wherein said at least one groove extends into said ferrule by an amount exceeding at least 3% of the inner diameter of said channel.

19. The device according to claim 5, wherein said substantially circular optical fiber resides within said substantially circular channel prior to said epoxy residing with said at least one groove.

20. The device according to claim 13, wherein said substantially circular optical fiber resides within said substantially circular channel prior to said epoxy residing with said at least one groove or notch.
